(19) United States
(12) Patent Application Publication
(10) Pub. No.: US 2008/0047501 A1
(43) Pub. Date: Feb. 28, 2008

(54) Cat and small animal harness

(76) Inventors: Sharon E. Madere, Midlothian, VA (US); Patricia M. Lacy, Rockville, VA (US); Janet Velenovsky, Montpelier, VA (US)

Correspondence Address: Kathleen R. Terry, 1666 Coffman Street #314, Falcon Heights, MN, 55108, US

(21) Appl. No.: 11/895,343

(22) Filed: Aug. 24, 2007

Related U.S. Application Data
(60) Provisional application No. 60/839,847, filed on Aug. 24, 2006.

(51) Int. Cl. A01K 27/00

(52) U.S. Cl. 119/863; 119/856

(57) ABSTRACT

An adjustable harness for an animal with a girth strap comprising a support base with a guide D-ring. A right and a left shoulder strap pass through the D-ring forming a double layer strap ending in a leash attachment. The shoulder straps pass proximally over the shoulders of the animal down the chest and through a sternum slide having two top slots and one bottom slot. The shoulder straps enter through the top slots and exit through the bottom slot, forming a second double layer strap, which is joined to the girth strap at the center of the belly. The girth strap is adjustable. The effective working length of the shoulder straps are adjustable through a slide stop on the first double layer strap. The shoulder straps are slid through the sternum slide to place the slide at the center of the chest, below the trachea. This adjustability is especially useful for lithe animals such as cats, ferrets, rabbits and dogs.

### RELATED APPLICATIONS

This application is based on and claims priority to U.S. Provisional Patent Application 60/839,847, filed Aug. 14, 2006.

### BACKGROUND OF THE INVENTION

Cats allowed to run free generally have very short lives. Dogs, traffic, disease, human cruelty, getting lost and poisons are only a few of the risks cats face. Nonetheless, cats enjoy the out-of-doors and benefit from the exercise of an outdoor walk. Cats can serve as service animals to provide therapy to shut-ins and sick persons. The American Bird Conservancy urges cat owners to keep the cat indoors or train it to accept a leash or harness. Cats do not accept collars, figure “8” and “H” harnesses and leashes as readily as do other pets. Attempting to attach a lead to the cat's collar is likely to meet with resistance and the cat will pull away to the point of choking. It is also a safety issue as many cats can easily slip out of a collar or regular harness.

Other small animals that, like cats, are lithe and high strung include ferrets, rabbits and dogs. Collars and harnesses now on the market tend to frighten and choke these animals. Small, lithe bodies can wriggle out of most harness, while tightening the harness may cause pain and panic. These animals also may be denied the joy of outdoors because of safety issues.

All of these animals are especially at risk during travel. Their litheness may allow them to escape and their quickness may make them impossible to catch before they are injured or killed.

The need exists to provide a means of controlling a cat or small animal. The means must be safe and comfortable and acceptable to the animal; cause no discomfort or pain; and be easily put on and adjusted.

### SUMMARY OF THE INVENTION

The preferred embodiment of the invention is a harness comprised of a girth strap extending around the girth of an animal from a point just posterior to the front legs to a point on the back just posterior to the shoulder. A right and a left shoulder strap pass over the girth strap at the neck through a support base attached to the girth strap and having a guide D-ring at the proximal edge of the support base, the guide D-ring of a diameter just slightly larger than the width of the straps, which passage of the shoulder straps causes the straps to lie one above the other, forming a first double layer strap. A second D-ring, just distal to the first and at the point of attachment of the support base to the girth strap, is provided for stability in order to keep the double layer strap in position. This first double layer strap has a moveable slide stop which can be adjusted to change the effective working length of the shoulder straps. The first double layer strap is long enough to extend past the slide stop to a leash attachment, which is a ring to which a leash may be attached. Proximally, the shoulders straps pass around the shoulders and down the front of the chest through a sternum slide which causes the two straps to form a second double layer strap which continues down to the center of the chest, between the legs and under the belly to attach to an O-ring to which the ends of the girth strap are also attached. The sternum slide is a unique three slot, flat connector with the slots arranged two at the top and one at the bottom of the sternum slide. The straps meet individually at the sternum slide, enter through the top two slots of the sternum slide and exit through the third slot of the sternum slide, forming a second double layer strap, continuing between the legs of the animal to attach to the O-ring of the girth strap at the belly. The slots of the sternum slide are narrow enough that the shoulder straps can be pulled through the sternum slide by human adjustment, but do not slide with the movements of the animal. The sternum slide may be made of any suitable material that is smooth, strong and light weight. Suitable materials include plastic, metals and nylon.

In an alternate, simple, embodiment, the support base is attached to a single D-ring at its proximal edge and to the girth strap at its distal edge. As in the first embodiment, the shoulder straps pass through the D-ring, forming a double layer strap ending in a leash attachment. Thus the double layer strap with the leach attachment is proximal to the girth strap, whereas in the first embodiment, the double layer strap is at the girth strap. The double layer strap may comprise a slide stop. The simple embodiment is particularly useful for a dog which may not require the adjustability features of the preferred embodiment.

The girth strap is provided with at least one buckle. The buckle or buckles are preferably placed at the back of the animal. It is most preferred to have buckles at each side of the support base, each equipped with a means for adjusting the length of the girth strap. The most convenient means for adjustment is the end of the girth strap, passed through the buckle slot, folded back on itself and fixably attached to a connector that is sized so that it may slide on the strap when pulled by a human, but narrow enough that the strap does not slide with the movements of the animal.

When a leash is attached to the leash attachment and pulled, the shoulder straps tighten and a gentle pressure is transmitted to the girth and shoulder straps to provide a gentle and comfortable snugging effect.

The size of the harness may be adjusted to fit the animal by moving the slide stop on the first double layer strap toward or away from the support base, changing the effective working lengths of the shoulder straps. After changing the working length of the shoulder straps, the sternum slide should be slid along the shoulder straps to be positioned about in the center of the chest, well below the trachea. The diameter of the girth strap is adjusted by the adjustment means thereon to be snug but not tight.

All straps may be formed of any suitable material. Nylon webbing is preferred, but polyester webbing, nylon or polyester fabric, leather or other strong, flexible materials may also be used.

The harness may be used with any leash, but preferably a bungee style leash is used, which is gathered so that it expands only with pull. This expansion further renders any pressure on the leash through to the girth and shoulder straps more gentle than would a fixed length leash.

In the following drawings and detailed description of the invention, the cat is selected as the exemplar animal. However, the harness is not limited to the cat, but may be used on any animal, such as the ferret, rabbit or dog.

### BRIEF DESCRIPTION OF THE DRAWINGS

FIG. 1 shows the harness configured as worn on an animal.

FIG. 2 shows the harness laid out flat.

FIG. 3 shows a side view of a cat wearing the harness.

FIG. 4 shows the shoulder attachment of the alternate embodiment of the harness.

### DETAILED DESCRIPTION OF THE INVENTION

Definitions: in the following description of the invention, the following terms have these meanings.

“Distal” means toward the tail.

“Double layer strap” is a strap with two individual straps resting one on top of the other

“Effective working length,” also denoted as “working length”: the length that defines the size of the shoulder straps of the harness.

“Proximal” means toward the head.

In the following drawings and detailed description of the invention, the cat is selected as the exemplar animal. However, the harness is not limited to the cat, but may be used on any animal, such as the ferret, rabbit or dog.

Cats are well known to be alert and sensitive animals who do not respond well to restraint or harsh treatment. The harness of this invention was scientifically designed to be non-threatening and gentle, while allowing safe and effective control of the cat. An additional advantage is that the harness is adjustable over a wide range of sizes to accommodate growth or weight gain of the animal.

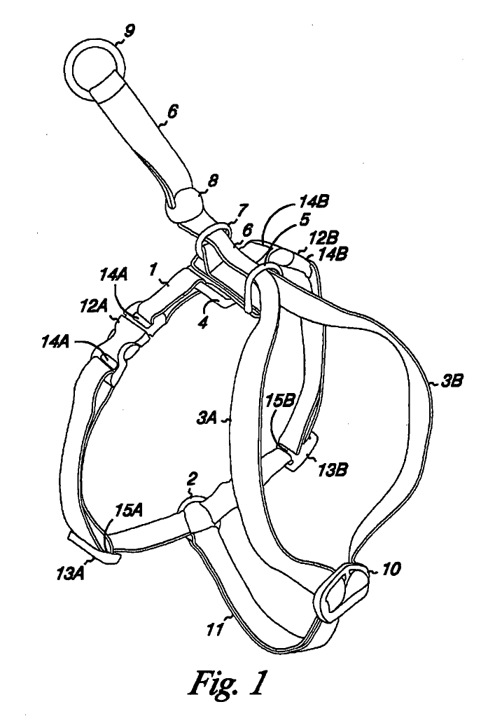

Turning to FIG. 1, the harness is comprised of a girth strap 1 extending around the girth of an animal from a point on the belly just posterior to the front legs to a point on the back just posterior to the shoulder. The two lengths of the girth strap 1 are joined through an O-ring 2 at about the center of the belly. A right shoulder strap 3A and a left shoulder strap 3B pass over the girth strap 1 at the neck through a support base 4 which is fixed at its distal end to the girth strap 1 and has a first guide D-ring 5 at its proximal edge, of a diameter just slightly larger than the width of the straps, which passage causes the shoulder straps 3A and 3B to lie one above the other, forming a first double layer strap 6. A second D-ring 7 at the point of attachment of the support base 4 to the girth strap 1, just distal to the first guide D-ring 5, is provided for stability in order to keep the first double layer strap 6 in position. This first double layer strap 6 has a moveable slide stop 8 which can be adjusted to change the effective working length of the shoulder straps. The first double layer strap 6 is long enough to extend past the slide stop 8 to a leash attachment 9, which is a ring to which a leash may be attached. The ring may be of any configuration: rectangular, O- or D-shaped. Proximally, the shoulders straps 3A and 3B pass around the shoulders and down to the center front of the chest through a sternum slide 10 which causes the two straps to form a second double layer strap 11 which continues down the center of the chest, between the legs and under the belly to attach to the O-ring 2 to which the ends of the girth strap are also attached. The sternum slide 10 is a unique three slot, flat connector with the slots arranged two at the top and one at the bottom of the sternum slide all slots being essentially parallel with the ground. The straps meet individually at the sternum slide 10, enter through the top two slots of the sternum slide and exit through the third slot of the sternum slide, forming a second double layer strap, continuing between the legs of the animal to attach to the O-ring 2 of the girth strap 1 at the belly. The slots of the slide are narrow enough that the straps can be pulled through the connector by human adjustment, but do not slide with the movements of the animal. The slide may be made of any suitable material that is smooth, strong and light weight. Suitable materials include plastic, metals and nylon.

The girth strap 1 is provided with at least one buckle. The buckle or buckles are preferably placed at the back of the animal. It is most preferred to have two buckles 12A and 12b, each equipped with a connector 13A or 13B for adjusting the length of the girth strap. The most convenient means for adjustment is the end of the girth strap, passed through the buckle slots 14A or 14B, folded back on itself and fixably attached to the center bar 15A or 15B of the connectors 13A and 13B. The slots 14A and 14B are sized so that they may slide on the girth strap 1 when pulled by a human, but narrow enough that they do not slide with the movements of the animal.

When a leash is attached to the leash attachment 9 and pulled, the shoulder straps 3A and 3B tighten and a gentle pressure is transmitted to the girth and shoulder straps to provide a gentle and comfortable snugging effect.

The size of the harness may be adjusted to fit the animal by moving the slide stop 8 on the first double layer strap 6 toward or away from the support base 4, changing its effective working length. After changing the working length of the shoulder straps 3A and 3B, the sternum slide 10 should be slid along the shoulder straps to be positioned about in the center of the chest, well below the trachea. The diameter of the girth strap 1 is adjusted by the adjustment means 13A and 13B, making the lengths of the girth strap approximately equal, putting the O-ring 2 at the center of the belly.

All straps may be formed of any suitable material. Nylon webbing is preferred, but polyester webbing, nylon or polyester fabric, leather or other strong, flexible materials may also be used.

The harness may be used with any leash, but preferably a bungee style leash is used, which is gathered so that it expands only with pull. This expansion further renders any pressure on the leash through to the girth and shoulder straps more gentle than would a fixed length leash.

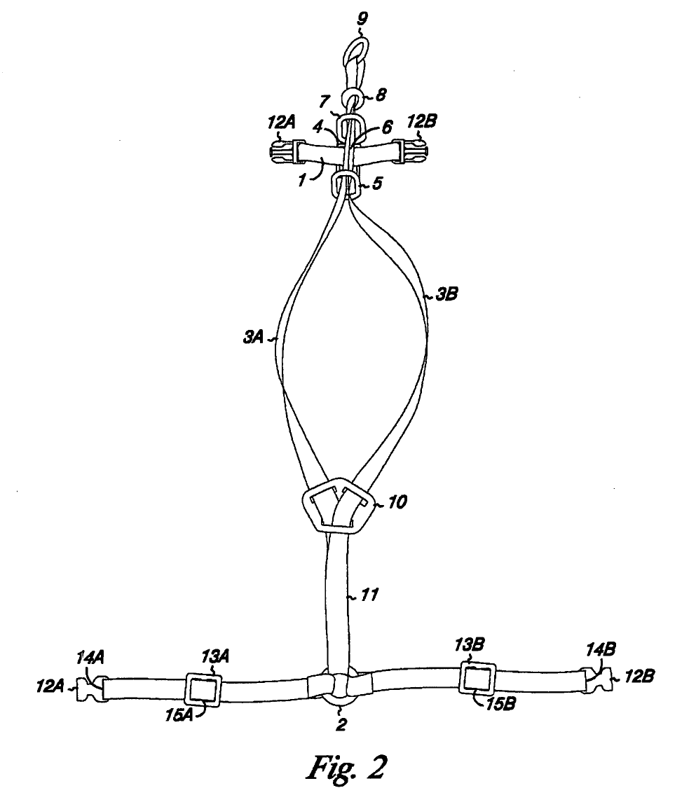

Turning to FIG. 2, which depicts the harness laid out flat, the harness is comprised of a girth strap 1. The two lengths of the girth strap, in use, are joined through an O-ring 2. Also shown are a right shoulder strap 3A and a left shoulder strap 3B, a support base 4 having a first D-ring 5, a second D-ring 7, and a first double layer strap 6. This first double layer strap has a moveable slide stop 8 and a leash attachment 9. The shoulders straps 3A and 3B pass a sternum slide 10 which causes the two straps to form a second double layer strap 11.

The girth strap 1 is provided with two buckles 12A and 12B, each equipped with a connector 13A and 13B for adjusting the length of the girth strap. The two lengths of the girth strap are passed through the buckle slots 14A and 14B, folded back and fixably attached to the center bars 15 A and 15 B of the connectors 13A and 13B.

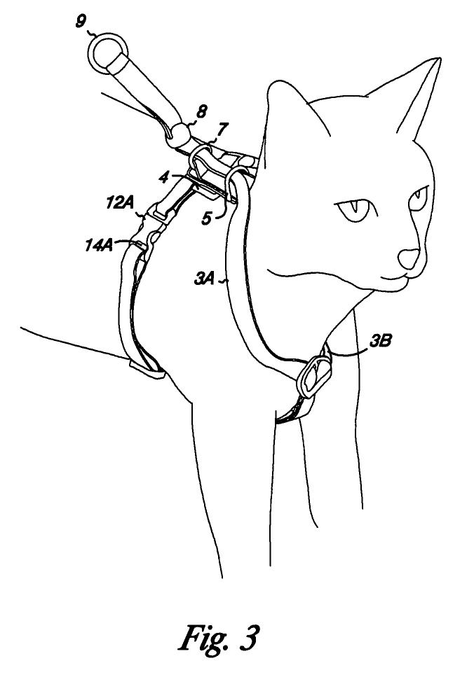

Turning to FIG. 3, the girth strap 1 goes around the body of the cat. The right shoulder strap 3A passes around the neck to join the left shoulder strap 3B at the anterior area of the sternum. The support base 4 of the girth strap 1 has D-rings 5 and 7, with a slide stop 8. The shoulder straps 3A and 3B pass through the D-rings 5 and 7 and end in a leash attachment 9. The right buckle 12A comprises a slot 14A through which the end of the girth strap 1 passes and is turned back on itself and attached to the adjustment connector 13A. The corresponding left side of the harness is not shown in this view, but it is to be understood that it is the mirror image of the right side shown here.

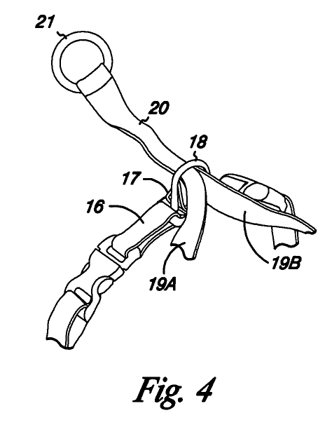

Turning to FIG. 4, a simple shoulder attachment has a support base 17, with a guide D-ring 18 through which shoulder straps 19A and 19B pass, forming a double layer strap 20 ending in a leash attachment 21. It is to be understood that this shoulder attachment is connected to the remainder of the harness 16 as in FIGS. 1 and 2. The simple embodiment is particularly useful for a dog which may not require the adjustability features of the preferred embodiment.

Looking again at FIG. 1, in use, the girth strap 1 is fitted around the girth of the cat and the adjustment means 13A and 13B are tightened or loosened to provide a comfortable fit that is snug but not tight. The shoulder straps 3A and 3B are passed around the neck of the cat and the working length of the shoulder straps is adjusted by sliding the shoulders straps through the guide D-ring 5 and moving the slide stop 8 to the desired position on the first double layer strap 6. The sternum slide 10 is adjusted to the desired position on the chest of the cat, avoiding the sensitive trachea area. FIG. 3 shows the harness properly fitted to a cat.

The inventors believe that the most unique features making this harness particularly useful for cats and other lithe animals are the sternum slide and the adjustability of the effective working length of the shoulder straps. These two features allow proper fitting, regardless of the shoulder width, belly diameter or general shape of the animal.

We claim:

1. A harness comprised of:
(A) a girth strap extending around the girth of an animal from a point just posterior to the front legs to a point on the back just posterior to the shoulder; and
(B) a support base attached to the girth strap at the center of the back of an animal, the support base comprising a guide D-ring place at the proximal edge of the support base; and
(C) a right and a left shoulder strap passing through the guide D-ring of the support base, forming a first double layer strap and passing proximally around the neck of the animal and entering individually through two top slots of a three-way connector forming a second double layer strap and exiting through the third slot of the connector between the front legs of the animal to attach to an O-ring on the girth strap at the center of the belly of the animal.

2. The girth strap of claim 1 comprising two lengths, each attached to the O-ring at the center of the belly of an animal.

3. The right and left shoulder strap of claim 1 attached to girth strap through the O-ring at the center of the belly of the animal.

4. The girth straps of claim 2 further comprising a buckle on each side of the support base

5. The girth straps of claim 4 each comprising a means for adjusting the length of the girth straps.

6. The first double layer strap of claim 1 further comprising a moveable slide stop.

7. The support base of claim 1 further comprising a second D-ring distal to the guide D-ring.

8. A sternum slide comprising three slots essentially parallel to the ground wherein two shoulder straps enter through the top 2 slots and exit through the bottom slot, forming a double layer strap.
